(19) United States
(12) Patent Application Publication
(10) Pub. No.: US 2021/0372873 A1
(43) Pub. Date: Dec. 2, 2021

(54) BELT TENSIONING MONITORING DEVICE

(71) Applicant: Aktiebolaget SKF, Goteborg (SE)

(72) Inventor: Andreas Karlsson, San Sebastián de los Reyes (ES)

(21) Appl. No.: 17/200,853

(22) Filed: Mar. 14, 2021

(30) Foreign Application Priority Data
May 26, 2020 (EP) 20380015.6

(51) Int. Cl. G01L 5/105; F16H 7/02; F16H 57/00; G01L 5/04

(52) U.S. Cl. CPC G01L 5/105; G01L 5/047; F16H 57/00; F16H 7/02

(57) ABSTRACT

Belt tensioning monitoring device for monitoring the belt tensioning of a belt of a belt drive system including a driving pulley and a driven pulley rotated by the driving pulley by way of the belt. The belt tensioning monitoring device is configured to determine the belt slip effect with at least two marks each located on one of the pulleys and sensors each configured to detect one mark and to send a signal to an electronic control unit.

### CROSS-REFERENCE TO RELATED APPLICATION(S)

This application claims priority to European Patent Application no. 20380015.6, filed May 26, 2020, the contents of which is fully incorporated herein by reference.

### TECHNICAL FIELD OF THE INVENTION

The present invention relates to the field of condition monitoring devices, and in particular to condition monitoring of belt tensioning.

### BACKGROUND OF THE INVENTION

Condition monitoring devices allow for the monitoring of the condition of a system without the need for manual inspection. These devices may be particularly advantageous in remote locations or locations which are difficult and/or dangerous to access.

Insufficient belt tension results in inadequate power transmission, reduced efficiency, and premature belt damage due to belt slip.

Excessive belt tension leads to high specific surface pressure, a risk of cross flexing, increased flexing stress and increased strain on the tension members with consequent premature fractures and elongation.

The correct belt tension is just enough tension to keep the belt from slipping under normal load conditions.

Belt slip is generally defined in a built-in slip table according to the speed of the driven pulley.

The belt slip occurs on the driver pulley so the speed of all driven pulleys is influenced by the same slip.

Usual belt slip magnitude is comprised between 1% and 2% what results in a belt slip effect comprised between 0.01 and 0.02.

There is a need to estimate if a belt of a belt drive system is correctly tensioned meanwhile running.

### SUMMARY OF THE INVENTION

The aim of the present invention is consequently to provide an improved belt condition monitoring device.

It is a particular object of the present invention to provide a belt tensioning monitoring device for monitoring the belt tensioning of a belt of a belt drive system comprising a driving pulley and a driven pulley rotated by the driving pulley thanks to the belt.

The belt tensioning monitoring device is configured to determine the belt slip effect with at least two marks each located on one of the pulleys and sensors each configured to detect one mark and to send a signal to an electronic control unit.

For example, the first mark is a reflective mark or tape and the first sensor is an optical sensor, such as, for example, an infrared sensor.

For example, the first mark is a magnetic element and the first sensor is a hall effect sensor configured for measuring the magnitude of a magnetic field generated by the magnetic element when passing through the sensor.

For example, the second mark is a reflective mark or tape and the second sensor is an optical sensor, such as, for example, an infrared sensor.

For example, the second mark is a magnetic element and the second sensor is a hall effect sensor configured for measuring the magnitude of a magnetic field generated by the magnetic element when passing through the sensor.

The electronic control unit may comprise an estimation module configured to determine the slip effect of the belt according to the driven pulley revolutions compared to the driving pulley.

According to another aspect, the invention concerns a belt drive system comprising a belt, a driving pulley, a driven pulley rotated by the driving pulley thanks to the belt and a belt tensioning monitoring device as explained above.

### BRIEF DESCRIPTION OF THE DRAWINGS

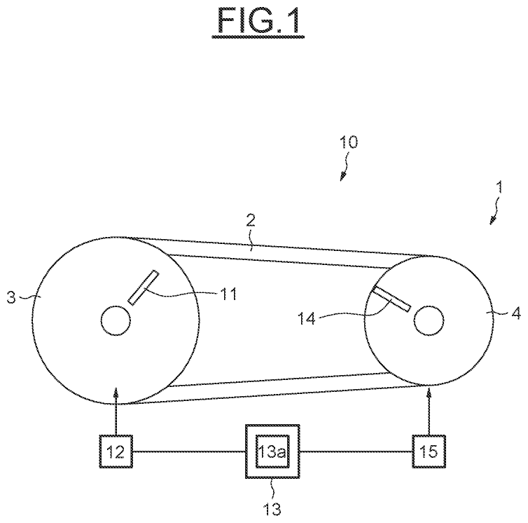

The present invention and its advantages will be better understood by studying the detailed description of specific embodiment given by way of non-limiting examples and illustrated by the appended FIG. 1 which illustrates a schematic view of a belt drive system comprising a belt tensioning monitoring device according to an embodiment of the invention.

### DETAILED DESCRIPTION OF THE INVENTION

Referring to FIG. 1, which illustrates an embodiment of a belt tensioning monitoring device 10 for monitoring the belt tensioning of a belt 2 of a belt drive system 1 comprising a driving pulley 3 and a driven pulley 4 rotated by the driving pulley 3 thanks to the belt 2. For example, the belt 2 is a V-shaped belt.

The belt tensioning monitoring device 10 comprises a first mark 11 provided on the driving pulley 3 and a first sensor 12 configured to detect the first mark 11 and to send the signal of rotational speed of the driving pulley 3 to an electronic control unit 13 of the belt tensioning monitoring device 10.

The belt tensioning monitoring device 10 further comprises a second mark 14 provided on the driven pulley 4 and a second sensor 15 configured to detect the second mark 14 and to send the signal of rotational speed of the driven pulley 4 to the electronic control unit 13.

The first mark 11 may be a reflective mark or tape and the first sensor 12 may be an optical sensor, such as an infrared sensor.

Alternatively, the first mark 11 may be a magnet and the first sensor 12 may be a hall effect sensor for measuring the magnitude of a magnetic field generated by the magnet when passing through the sensor 12.

The second mark 14 may be a reflective mark or tape and the second sensor 15 may be an optical sensor, such as an infrared sensor.

Alternatively, the second mark 14 may be a magnet and the second sensor 15 may be a hall effect sensor for measuring the magnitude of a magnetic field generated by the magnet when passing through the sensor 15.

The electronic control unit 13 of the belt tensioning monitoring device 10 comprises an estimation module 13a configured to determine the slip effect of the belt 2 according to the driven pulley 4belt 2 revolutions compared to the driving pulley 3.

Thanks to the invention, slip effect of the belt may be efficiently estimated and thus the belt tensioning may be characterized.

The user may thus know if the tension of the belt is correct and adjust its tension or replace the belt if necessary.

It is to be understood for the present invention that belt means a single strand belt or a multibelt, and that the belt is for instance of the groove type or the V type, but not necessarily.

1. A belt tensioning monitoring device for monitoring the belt tensioning of a belt of a belt drive system comprising:
a driving pulley, and
a driven pulley rotated by the driving pulley by way of the belt, wherein the belt tensioning monitoring device is configured to determine the belt slip effect with at least two marks each located on one of the pulleys and sensors each configured to detect one mark and to send a signal to an electronic control unit.

2. The belt tensioning monitoring device according to claim 1, wherein the first mark is a reflective mark or tape and the first sensor is an optical sensor.

3. The belt tensioning monitoring device according to claim 1, wherein the first mark is a magnetic element and the first sensor is a hall effect sensor configured for measuring the magnitude of a magnetic field generated by the magnetic element when passing through the sensor.

4. The belt tensioning monitoring device according to claim 1, wherein the second mark is a reflective mark or tape and the second sensor is an optical sensor.

5. The belt tensioning monitoring device according to claim 1, wherein the second mark is a magnetic element and the second sensor is a hall effect sensor configured for measuring the magnitude of a magnetic field generated by the magnetic element when passing through the sensor.

6. The belt tensioning monitoring device according to claim 1, wherein the electronic control unit comprises an estimation module configured to determine the slip effect of the belt according to the driven pulley revolutions compared to the driving pulley.

7. A belt drive system comprising:
a belt,
a driving pulley,
a driven pulley rotated by the driving pulley by way of the belt, and
a belt tensioning monitoring device that is configured to determine the belt slip effect with at least two marks each located on one of the pulleys and sensors each configured to detect one mark and to send a signal to an electronic control unit.
